(19) United States
(12) Patent Application Publication
(10) Pub. No.: US 2011/0128261 A1
(43) Pub. Date: Jun. 2, 2011

(54) LIQUID CRYSTAL DISPLAY PANEL AND LIQUID CRYSTAL DISPLAY DEVICE

(75) Inventors: CHAO-YI HUNG, Miao-Li County (TW); CHIH-CHIEH HSU, Miao-Li County (TW)

(73) Assignee: CHIMEI INNOLUX CORPORATION, Miao-Li County (TW)

(21) Appl. No.: 12/915,059

(22) Filed: Oct. 29, 2010

(30) Foreign Application Priority Data
Dec. 1, 2009 (CN) 200910310742.3

(51) Int. Cl. G09G 3/36; G09G 5/00

(52) U.S. Cl. 345/205; 345/87; 345/92

(57) ABSTRACT

A liquid crystal display panel includes a plurality of scan lines, a plurality of data lines perpendicular to and insulatively intersecting the scan lines and a plurality of scanning-signal transmission lines insulatively disposed between the data lines and parallel to the data lines. The scanning-signal transmission lines provide scanning signals to the scan lines.

### BACKGROUND

1. Technical Field

The present disclosure relates in general to a liquid crystal display panel and a liquid crystal display device.

2. Description of Related Art

Liquid crystal display devices have been widely applied to electronic apparatuses, such as televisions, notebook computers, mobile telephones, personal digital assistants (PDA) and the like, because they are small, light-weighted, thin and low power-consumptive, and have no flicker and low radiation.

A liquid crystal display panel of the liquid crystal display device usually includes a display region for displaying images and a non-display region for installing driving circuits and traces. At present, the driving circuit disposed in the non-display region includes a data driving circuit and a scan driving circuit. Data lines and scan lines inside the liquid crystal display panel are perpendicular to each other. Thus, the data driving circuit and its layout and the scan driving circuit and its layout are respectively disposed in two regions outside the display region and extending in two different directions. Consequently, the liquid crystal display panel has a larger non-display region. Correspondingly, the size of the display region is also restricted so that the user cannot enjoy wider and comfortable visual feeling.

### SUMMARY

According to a first exemplary embodiment of the present disclosure, a liquid crystal display panel is provided. The liquid crystal display panel includes a plurality of parallel scan lines, a plurality of parallel data lines perpendicular to and insulatively intersecting the scan lines and a plurality of scanning-signal transmission lines disposed between the data lines and insulatively to and parallel to the data lines. The scanning-signal transmission lines provide scanning signals to the scan lines.

According to a second exemplary embodiment of the present disclosure, a liquid crystal display panel is provided. The liquid crystal display panel includes a plurality of parallel first signal lines, and a plurality of parallel second signal lines perpendicular to and insulatively intersecting the first signal lines. The first signal lines are scan lines and the second signal lines are data lines. Alternatively, the first signal lines are data lines and the second signal lines are scan lines. The liquid crystal display panel further includes a plurality of second signal transmission lines disposed between the first signal lines and insulatively to and parallel to the first signal lines, and the second signal transmission lines provides second signals to the second signal lines.

According to a third exemplary embodiment of the present disclosure, a liquid crystal display device including a liquid crystal display panel and a driving circuit is provided. The liquid crystal display panel includes a display region and a non-display region. The display region includes a plurality of scan lines extending in a first direction; a plurality of data lines extending in a second direction perpendicular to the first direction; and a plurality of scanning-signal transmission lines disposed between the data lines and parallel to the data lines. The data lines and the scanning-signal transmission lines extend to one side of the display region in the second direction to define the non-display region. The driving circuit is disposed in the non-display region. The driving circuit is electrically connected to the data lines and electrically connected to the scan lines through the scanning-signal transmission lines.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic circuit diagram showing a liquid crystal display device according to a first embodiment of the disclosure.

FIG. 2 is a schematically partially enlarged view showing the liquid crystal display device of FIG. 1.

FIG. 3 shows waveforms of driving signals of the liquid crystal display device of FIG. 1.

FIG. 4 is a schematic circuit diagram showing a liquid crystal display device according to a second embodiment of the disclosure.

### DETAILED DESCRIPTION

### First Embodiment

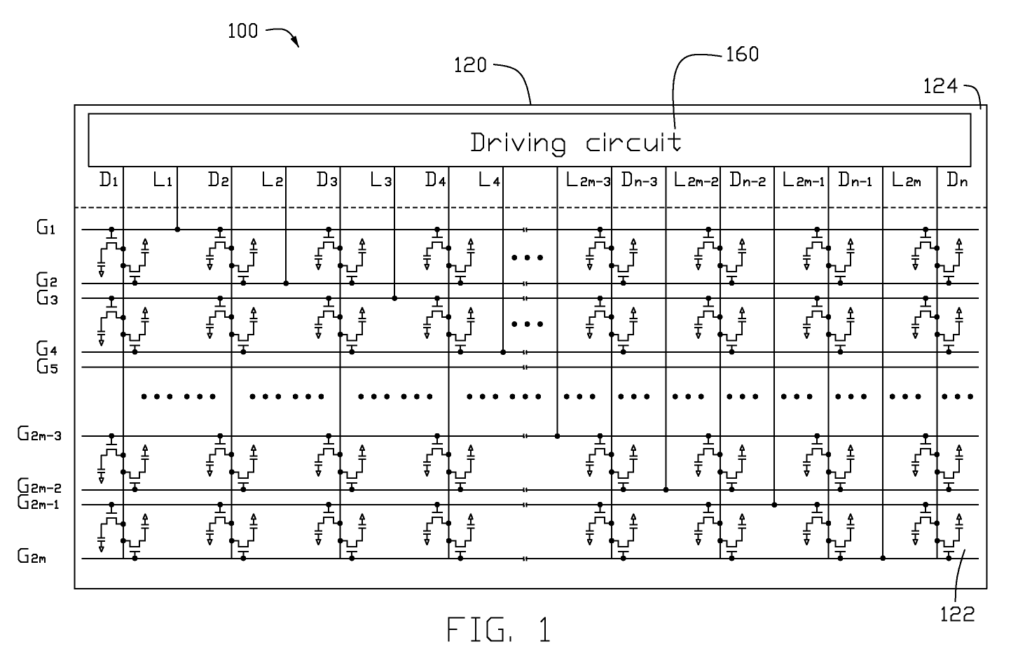

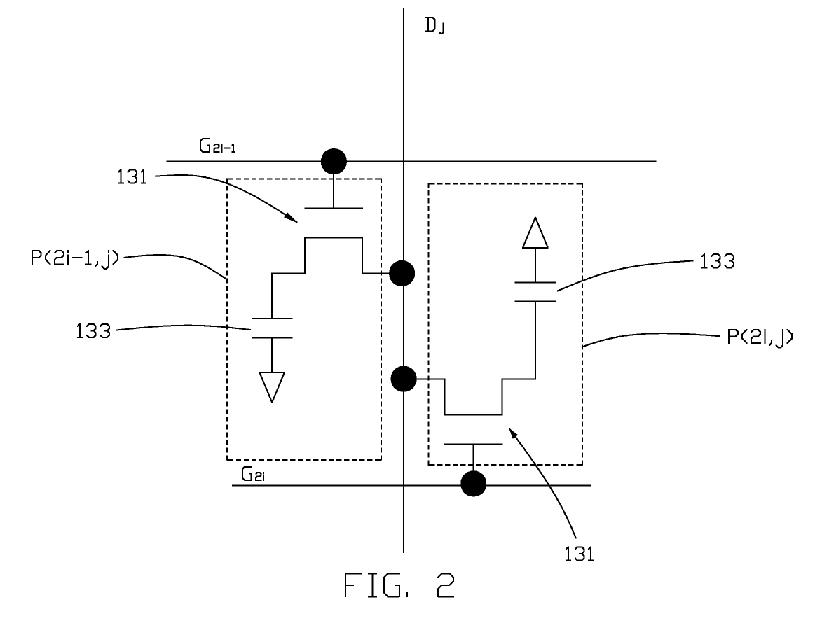

FIG. 1 is a schematic circuit diagram showing a liquid crystal display device 100 according to a first embodiment of the disclosure. FIG. 2 is a schematically partially enlarged view showing the liquid crystal display device 100 of FIG. 1. Referring to FIGS. 1 and 2, the liquid crystal display device 100 includes a liquid crystal display panel 120 and a driving circuit 160. The liquid crystal display panel 120 includes a plurality of parallel scan lines G₁ to G₂ₘ, a plurality of parallel data lines D₁ to Dₙ perpendicular to and insulatively intersecting the scan lines, and m and n are natural numbers.

Neighboring two of the scan lines G₂ᵢ₋₁ and G₂ᵢ are defined as one scan line set. Each scan line set G₂ᵢ₋₁ and G₂ᵢ and the data lines D₁ to Dₙ define a plurality of pixel units. A pixel unit P(2i−1,j) connected to the data line Dⱼ and a pixel unit P(2i,j) connected to the data line Dⱼ are respectively disposed on two sides of the data line Dⱼ, and i and j are natural numbers, 1≦i≦m, and 1≦j≦n. The pixel unit P(2i−1,j) is connected to the scan line G₂ᵢ₋₁ and the pixel unit P(2i,j) is connected to the scan line G₂ᵢ. In other words, the pixel unit P(2i−1,j) and the pixel unit P(2i,j) share the same data line Dⱼ under the control of different scan lines G₂ᵢ₋₁ and G₂ᵢ. Each pixel unit includes a thin film transistor 131 and a liquid crystal capacitor 133. The thin film transistor 131 of the pixel unit P(2i−1,j) has a gate connected to the scan line G₂ᵢ₋₁, a source connected to the data line Dⱼ and a drain connected to the corresponding liquid crystal capacitor 133. The thin film transistor 131 of the pixel unit P(2i,j) has a gate connected to the scan line G₂ᵢ, a source also connected to the data line Dⱼ and a drain connected to the corresponding liquid crystal capacitor 133.

The liquid crystal display panel 120 further includes a plurality of scanning-signal transmission lines L₁ to L₂ₘ insulatively disposed between the data lines D₁ to Dₙ and parallel to the data lines D₁ to Dₙ. The scanning-signal transmission lines L₁ to L₂ₘ are respectively connected to the scan lines in a one-to-one manner. In this embodiment, n≦2m+1, and the scanning-signal transmission line Lᵢ is disposed between the neighboring two data lines Dⱼ and Dⱼ₊₁, and 1≦i≦2m and 1≦j≦n−1. At most one scanning-signal transmission line is disposed between the neighboring two data lines Dⱼ and Dⱼ₊₁.

When n=2m+1, preferably, one scanning-signal transmission line Lᵢ is just disposed between the neighboring two data lines Dⱼ and Dⱼ₊₁. When n>2m+1, there would be no scanning-signal transmission line disposed between at least two neighboring data lines Dⱼ and Dⱼ₊₁. At this time, preferably, no scanning-signal transmission line is disposed between the data lines in the middle region, and the scanning-signal transmission lines and the data lines in the regions on two sides of the middle region are disposed symmetrically. More specifically, the 1^{st} to m^{th} scanning-signal transmission lines L₁ to Lₘ are disposed between the 1^{st} to (m+1)^{th} data lines D₁ to Dₘ₊₁, the (m+1)^{th} to (2m)^{th} scanning-signal transmission lines Lₘ₊₁ to L₂ₘ are disposed between the last 1^{st} to (m+1)^{th} data lines Dₙ to Dₙ₋₍ₘ₊₁₎, and no scanning-signal transmission line is disposed between the (m+1)^{th} data line and the last (m+1)^{th} data lines Dₘ₊₁ to Dₙ₋₍ₘ₊₁₎. For example, when m=272 and n=720, no scanning-signal transmission line is disposed between the data lines D₂₇₃ and D₄₄₈, and in the region having the data lines D₁ to D₂₇₃ and in the region having the data lines D₄₄₈ to D₇₂₀, the scanning-signal transmission lines and the data lines are disposed symmetrically.

The liquid crystal display panel 120 is divided into a display region 122 and a non-display region 124. The scan lines G₁ to G₂ₘ, the data lines D₁ to Dₙ and the scanning-signal transmission lines L₁ to L₂ₘ are disposed in the display region 122. The data lines D₁ to Dₙ and the scanning-signal transmission lines L₁ to L₂ₘ extend to one side of the display region 122 in an extending direction thereof to define the non-display region 124.

The driving circuit 160, disposed in the non-display region 124, drives the data lines D₁ to Dₙ and drives the scan lines G₁ to G₂ₘ through the scanning-signal transmission lines L₁ to L₂ₘ. The driving circuit 160 includes 2m scanning signal output terminals (not labeled) and n data signal output terminals (not labeled). The 2m scanning signal output terminals are respectively electrically connected to the scanning-signal transmission lines L₁ to L₂ₘ in a one-to-one manner. The n data signal output terminals are respectively electrically connected to the data lines D₁ to Dₙ in a one-to-one manner. The driving circuit 160 may be a driving chip having 2m scanning signal output terminals and n data signal output terminals, and 2m scanning signal output terminals output scanning signals which are transmitted to the scan lines G₁ to G₂ₘ through the scanning-signal transmission lines L₁ to L₂ₘ, and n data signal output terminals output data signals to the data lines D₁ to Dₙ.

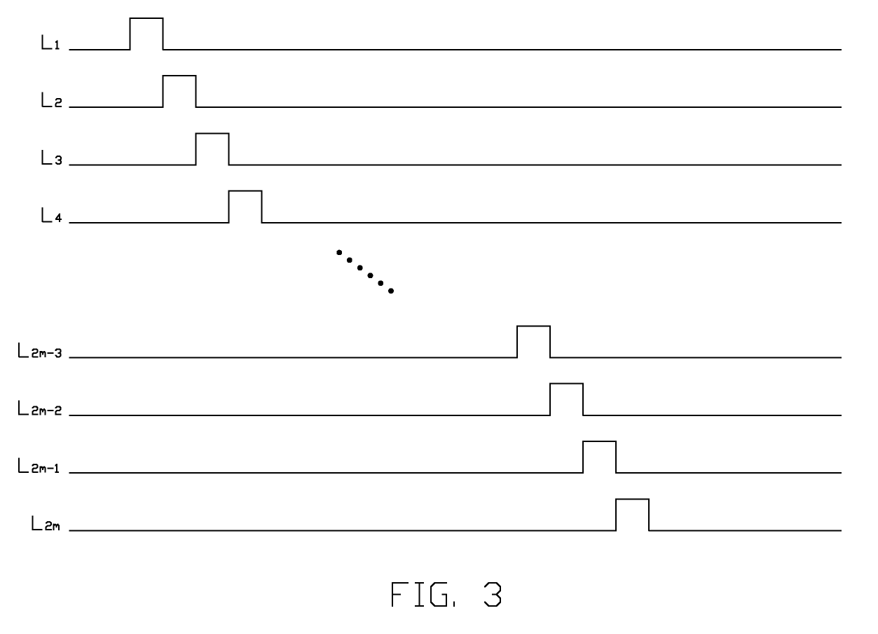

FIG. 3 shows waveforms of driving signals on the scanning-signal transmission lines L₁ to L₂ₘ, i.e. the waveforms of the scanning signals on the scan lines G₁ to G₂ₘ. When the liquid crystal display device 100 is in normal operation, the 2m scanning signal output terminals of the driving circuit 160 sequentially output a series of scanning signals which are transmitted to the scan lines G₁ to G₂ₘ through the scanning-signal transmission lines L₁ to L₂ m. At the same time, the n data signal output terminals of the driving circuit 160 also sequentially output a plurality of data signals to the data lines D₁ to Dₙ.

In practice, the scanning signal is a series of high voltage pulses with the time length T. Usually, the time for the high voltage pulses to be applied to the scan lines G₁ to G₂ₘ is defined as a frame time. At any moment within one frame time, only one scan line is applied with the high voltage pulse. Taking the scan line set G₂ᵢ₋₁ and G₂ᵢ and the data line Dⱼ as an example, the operation principle of the liquid crystal display device 100 may be briefly described in the following.

When the (2i−1)^{th} scanning signal output terminal of the driving circuit 160 applies the high voltage pulse to the scan line G₂ᵢ₋₁ through the scanning-signal transmission line L₂ᵢ₋₁ during the time T, the thin film transistor 131 of the pixel unit P(2i−1,j) connected to the scan line G₂ᵢ₋₁ turns on. At this time, the jth data signal output terminal of the driving circuit 160 outputs a first data signal which is written into the liquid crystal capacitor 133 of the pixel unit P(2i−1,j) through the data line Dⱼ and the source and the drain of the thin film transistor 131 of the pixel unit P(2i−1,j) so that the pixel unit P(2i−1,j) displays. Next, the (2i−1)^{th} scanning signal output terminal of the driving circuit 160 stops applying the high voltage pulse to the scanning-signal transmission line L₂ᵢ₋₁, and the thin film transistor 131 of the pixel unit P(2i−1,j) connected to the scan line G₂ᵢ₋₁ turns off. Moreover, the (2i)^{th} scanning signal output terminal of the driving circuit 160 applies the high voltage pulses to the scan line G₂ᵢ through the scanning-signal transmission line L₂ᵢ, so that the thin film transistor 131 of the pixel unit P(2i,j) connected to the scan line G₂ᵢ turns on. At this time, the j^{th} data signal output terminal of the driving circuit 160 outputs a second data signal which is written into the liquid crystal capacitor 133 of the pixel unit P(2i,j) through the data line Dⱼ and the source and the drain of the thin film transistor 131 of the pixel unit P(2i,j) so that the pixel unit P(2i,j) displays.

Compared with the prior art, the liquid crystal display panel 120 and the liquid crystal display device 100 according to the first embodiment of the disclosure include the scanning-signal transmission lines L₁ to L₂ₘ disposed between the data lines D₁ to Dₙ and parallel to the data lines D₁ to Dₙ. The scanning-signal transmission lines L₁ to L₂ₘ can transmit the scanning signals to the scan lines G₁ to G₂ₘ, so that it is enough to install the driving circuit 160, driving the data lines D₁ to Dₙ and driving the scan lines G₁ to G₂ₘ through the scanning-signal transmission lines L₁ to L₂ₘ, in one region on one side of the display region 122. Compared with the prior art, in which the non-display region has two regions disposed outside the display region and extending in two different directions, the area of the non-display region 124 of the first embodiment of the disclosure is smaller so that the ratio of the area of the display region 122 to the area of the non-display region 124 is increased, the advantageous effect of the narrow side can be achieved, and the user can enjoy wide and comfortable visual feeling. Meanwhile, in the first embodiment of the disclosure, the functions of the scan driving circuit and the data driving circuit are integrated into the driving circuit 160, so that the packaging process of the first embodiment of the disclosure is simpler than that of the prior art, in which two driving circuits are provided.

In addition, according to the above-mentioned operation principle, in the liquid crystal display device 100 of the first embodiment of the disclosure, the two scanning lines G₂ᵢ₋₁ and G₂ᵢ are disposed on the same row and the pixel units P(2i−1,j) and P(2i,j) disposed on two side of the data line Dⱼ may share the same data line Dⱼ by timing division. That is, the pixel units P(2i−1,j) and P(2i,j) disposed on the same row and on the two sides of the data line Dⱼ share the j^{th} data signal output terminal of the driving circuit 160 in a time-division manner. Thus, the number of the data lines of the liquid crystal display device 100 is equal to one half that of the typical liquid crystal display device. Furthermore, disposition of the scanning-signal transmission lines L₁ to L₂ₘ between the data lines D₁ to Dₙ does not increase any layout difficulty in the extension of the data line. Meanwhile, the number of the data signal output terminals of the liquid crystal display device 100 is equal to one half that of the typical liquid crystal display device. Furthermore, the disposition of the scanning signal output terminals between the data signal output terminals and alternately output of the scanning signals and the data signals from the integrated driving circuit 160 do not increase the package and layout difficulty of the driving circuit 160.

### Second Embodiment

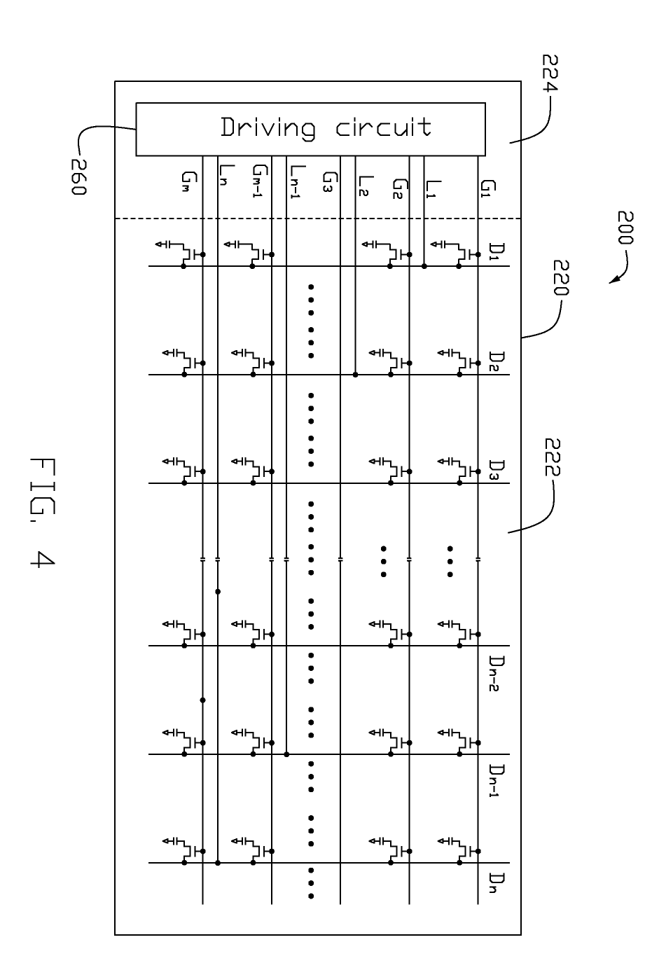

FIG. 4 is a schematic circuit diagram showing a liquid crystal display device 200 according to a second embodiment of the disclosure. Referring to FIG. 4, the difference between the liquid crystal display device 200 and the liquid crystal display device 100 of the first embodiment resides in that a liquid crystal display panel 220 includes a plurality of parallel scan lines G₁ to Gₘ, a plurality of parallel data lines D₁ to Dₙ perpendicular to and insulatively intersecting the scan lines G₁ to Gₘ, and a plurality of data signal transmission lines L₁ to Lₙ insulatively disposed between the scan lines G₁ to Gₘ and parallel to the scan lines G₁ to Gₘ. The data signal transmission lines L₁ to Lₙ are respectively electrically connected to the data lines D₁ to Dₙ in a one-to-one manner for providing data signals to the data lines D₁ to Dₙ. In this embodiment, m>n, the data signal transmission line Lⱼ is disposed between the neighboring two scan lines Gᵢ and Gᵢ₊₁, and at most one data signal transmission line is disposed between the neighboring two scan lines Gᵢ and Gᵢ₊₁, and 1≦i≦m−1.

The liquid crystal display panel 220 is divided into a display region 222 and a non-display region 224. The scan lines G₁ to Gₘ, the data lines D₁ to Dₙ and the data signal transmission lines L₁ to Lₙ are disposed in the display region 222. The scan lines G₁ to Gₘ and the data signal transmission lines L₁ to Lₙ extend to one side of the display region 222 in an extending direction thereof to define the non-display region 224.

In this embodiment, the liquid crystal display panel 220 and the liquid crystal display device 200 include the data signal transmission lines L₁ to Lₙ disposed between the scan lines G₁ to Gₘ and parallel to the scan lines G₁ to Gₘ. The data signal transmission lines L₁ to Lₙ transmit data signals to the data lines D₁ to Dₙ and a driving circuit 260, disposed in a region on one side of the display region 222, is enough for driving the scan lines G₁ to Gₘ and the data lines D₁ to Dₙ. Compared with the prior art, in which the non-display region has two regions disposed outside the display region and extending in two different directions, the non-display region 222 of the second embodiment of the disclosure is smaller so that the ratio of the area of the display region 222 to the area of the non-display region 224 is increased, the advantageous effect of the narrow side can be achieved, and the user can enjoy wide and comfortable visual feeling. Meanwhile, only one driving circuit 260 is provided in the second embodiment of this disclosure. Compared with the prior art, in which two driving circuits are provided, the package processes of the second embodiment of the disclosure can be simplified.

While the disclosure has been described by way of example and in terms of the preferred embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A liquid crystal display panel, comprising:
a plurality of scan lines;
a plurality of data lines perpendicular to and insulatively intersecting the scan lines; and
a plurality of scanning-signal transmission lines insulatively disposed between the data lines and parallel to the data lines, wherein the scanning-signal transmission lines provide scanning signals to the scan lines.

2. The liquid crystal display panel according to claim 1, wherein the scanning-signal transmission lines are respectively connected to the scan lines in a one-to-one manner.

3. The liquid crystal display panel according to claim 2, wherein:
the scan lines comprise 2m scan lines;
the data lines comprise n data lines, (2i−1)^{th} and 2i^{th} scan lines are defined as a scan line set; and
each scan line set and the data lines define a plurality of pixel units arranged in one row, two of the pixel units on two sides of each of the data lines and on the same row share the same data line, and the two pixel units are respectively controlled by the (2i−1)^{th} and 2i^{th} scan lines, wherein i, m and n are natural numbers, and 1≦i≦m.

4. The liquid crystal display panel according to claim 3, wherein:
the scanning-signal transmission lines comprise 2m scanning-signal transmission lines;
each of the scanning-signal transmission lines is disposed between neighboring two of the data lines; and
at most one scanning-signal transmission line is disposed between neighboring two of the data lines.

5. The liquid crystal display panel according to claim 4, wherein n≧2m+1, 1^{st} to m^{th} scanning-signal transmission lines are disposed between the 1^{st} to (m+1)^{th} data lines and (m+1)^{th} to (2m)^{th} scanning-signal transmission lines are disposed between last 1^{st} to (m+1)^{th} data lines.

6. The liquid crystal display panel according to claim 3, wherein:
each of the pixel units includes a thin film transistor and a liquid crystal capacitor;
two of the pixel units, disposed in the i^{th} row and sharing the j^{th} data line, are respectively defined as a first pixel unit and a second pixel unit;
the thin film transistor of the first pixel unit has a gate connected to the (2i−1)^{th} scan line, a source connected to the j^{th} data line and a drain connected to a corresponding liquid crystal capacitor; and
the thin film transistor of the second pixel unit has a gate connected to the (2i)^{th} scan line, a source connected to the j^{th} data line and a drain connected to a corresponding liquid crystal capacitor, wherein j is a natural number and 1≦j≦n.

7. The liquid crystal display panel according to claim 1, wherein:
the liquid crystal display panel is divided into a display region and a non-display region;
the scan lines, the data lines and the scanning-signal transmission lines are disposed in the display region;
the data lines and the scanning-signal transmission lines extend to one side of the display region in an extending direction thereof to define the non-display region; and
a driving circuit electrically connected to the data lines and the scanning-signal transmission lines is disposed in the non-display region.

8. A liquid crystal display panel, comprising:
a plurality of first signal lines;
a plurality of second signal lines perpendicular to and insulatively intersecting the first signal lines, the first signal lines being scan lines and the second signal lines being data lines or the first signal lines being data lines and the second signal lines being scan lines; and
a plurality of second signal transmission lines insulatively disposed between the first signal lines and parallel to the first signal lines, wherein the second signal transmission lines are respectively connected to the second signal lines in a one-to-one manner.

9. The liquid crystal display panel according to claim 8, wherein:
the first signal lines are the scan lines;
the second signal lines are the data lines; and
the second signal transmission lines are data signal transmission lines, each of the data signal transmission lines is disposed between neighboring two of the scan lines, and at most one data signal transmission line is disposed between neighboring two of the scan lines.

10. The liquid crystal display panel according to claim 8, wherein:
the liquid crystal display panel is divided into a display region and a non-display region;
the scan lines, the data lines and the data signal transmission lines are disposed in the display region;
the scan lines and the data signal transmission lines extend to one side of the display region in an extending direction thereof to define the non-display region; and
a driving circuit, electrically connected to the scan lines and to the data signal transmission lines, is disposed in the non-display region.

11. A liquid crystal display device, comprising a liquid crystal display panel and a driving circuit,
the liquid crystal display panel comprising a display region and a non-display region;
the display region comprising: a plurality of scan lines extending in a first direction; a plurality of data lines extending in a second direction perpendicular to the first direction; and a plurality of scanning-signal transmission lines disposed between the data lines and parallel to the data lines;
the data lines and the scanning-signal transmission lines extending to one side of the display region in the second direction to define the non-display region; and
the driving circuit, disposed in the non-display region, electrically connected to the data lines and electrically connected to the scan lines through the scanning-signal transmission lines.

12. The liquid crystal display device according to claim 11, wherein:
the scan lines comprise 2m scan lines;
the data lines comprise n data lines;
the (2i−1)^{th} and 2i^{th} scan lines are defined as a scan line set, each scan line set and the data lines define a plurality of pixel units arranged in one row; and
two of the pixel units on two sides of each of the data lines and in the same row share the same data line, and the two pixel units are respectively controlled by the (2i−1)^{th} and 2i^{th} scan lines, wherein i, m and n are natural numbers, and 1≦i≦m.
